(19) United States
(12) Patent Application Publication
(10) Pub. No.: US 2013/0073855 A1
(43) Pub. Date: Mar. 21, 2013

(54) Collision Based Multivariate Signature Scheme

(71) Applicants: Aviad Kipnis, Efrat (IL); Yaron Sella, Beit Nekofa (IL)

(72) Inventors: Aviad Kipnis, Efrat (IL); Yaron Sella, Beit Nekofa (IL)

(73) Assignee: NDS LIMITED, Staines, Middlesex (GB)

(21) Appl. No.: 13/643,511

(22) PCT Filed: Nov. 22, 2010
(86) PCT No.: PCT/IB10/55316

§ 371 Date: Nov. 16, 2012

(30) Foreign Application Priority Data
May 16, 2010 (IL) 205803

(51) Int. Cl. H04L 9/30

(52) U.S. Cl. 713/171

(57) ABSTRACT

A cryptographic method and system is described, the method and system including providing a key pair that includes a private key and a corresponding public key, which defines a multivariate polynomial mapping, computing, using a processor and the private key, a digital signature for a message such that a first application of the mapping to the digital signature gives a first result, and a second application of the mapping to the message gives a second result that is equal to the first result, and conveying the message with the digital signature to a recipient for authentication using the public key. Related hardware, methods, and systems are also described.

### FIELD OF THE INVENTION

The present invention relates generally to methods and systems of cryptography, and specifically to public-key signature schemes.

### BACKGROUND OF THE INVENTION

Public-key cryptographic techniques are widely used for encryption and authentication of electronic documents. Such techniques use a mathematically-related key pair: a secret private key and a freely-distributed public key. For authentication, the sender uses a private key to compute an electronic signature over a given message, and then transmits the message together with the signature. The recipient verifies the signature against the message using the corresponding public key, and thus confirms that the document originated with the holder of the private key and not an impostor.

Commonly-used public-key cryptographic techniques, such as the Rivest Shamir Adleman (RSA) algorithm, rely on numerical computations over large finite fields. To ensure security against cryptanalysis, these techniques require the use of large signatures, which are costly, in terms of memory and computing power, to store and compute. These demands can be problematic in applications such as smart cards, in which computing resources are limited.

Various alternative public-key signature schemes have been developed in order to reduce the resource burden associated with cryptographic operations. One class of such schemes is based on solution of multivariate polynomial equations over finite fields. These schemes can offer enhanced security while operating over relatively small finite fields. Most attention in this area has focused on multivariate quadratic (MQ) equations. A useful survey of work that has been done in this area is presented by Wolf and Preneel in “Taxonomy of Public Key Schemes Based on the Problem of Multivariate Quadratic Equations,” Cryptology ePrint Archive, Report 2005/077 (2005), which is incorporated herein by reference.

### SUMMARY

Embodiments of the present invention that are described hereinbelow provide a multivariate polynomial scheme for public-key signature with enhanced computational efficiency.

There is therefore provided, in accordance with an embodiment of the present invention, a cryptographic method, including providing a key pair that includes a private key and a corresponding public key, which defines a multivariate polynomial mapping. A processor computes, using the private key, a digital signature for a message such that a first application of the mapping to the digital signature gives a first result, and a second application of the mapping to the message gives a second result that is equal to the first result. The message with the digital signature is conveyed to a recipient for authentication using the public key.

In a disclosed embodiment, the method includes receiving the message with the digital signature, and authenticating the message by computing the first and second results using the multivariate polynomial mapping defined by the public key, and verifying that the first and second results are equal.

In some embodiments, computing the digital signature includes computing a predefined hash function over the message to produce an input vector H, and finding the digital signature X under the multivariate polynomial mapping P( ) such that X≠H while P(H)=P(X).

Typically, the private key defines a set of multivariate equations, and providing the key pair includes generating the public key by mixing the multivariate equations using linear transformations and/or mixing the variables in the equations using linear transformations. Additionally or alternatively, providing the key pair includes generating the public key by deleting one or more of the multivariate equations and/or one or more of the variables from the public key.

In some embodiments, computing the digital signature includes applying a univariate polynomial function, corresponding to the multivariate polynomial mapping, over a finite field including a unity element 1, wherein the finite field is defined such that 1 has multiple roots. Typically, the finite field is an extension field Fₚk including members that correspond to vectors having k elements over a base field of p elements, and the univariate polynomial function f is selected so that for a vector H in Fₚk, f(H)=H^{l}, such that l is a sum of integer powers of p, and p^{k}−1 is divisible by l. Thus, computing the digital signature X includes deriving the vector H from the message, and computing, in polynomial terms, X=gH, wherein g is a polynomial such that g^{l}=1.

In disclosed embodiments, the multivariate polynomial mapping is a quadratic mapping. In one embodiment, the private key defines a set of quadratic equations in accordance with an unbalanced oil and vinegar (UOV) scheme, such that the equations include first and second groups of variables having respective first and second sizes, wherein the variables in the second group do not self-interact, and the ratio between the first and second sizes is selected so as to ensure that the UOV scheme is secure.

There is also provided, in accordance with an embodiment of the present invention, a cryptographic method, including receiving a message with a digital signature, for verification using a predefined public key. A multivariate polynomial mapping based on the public key is applied to the digital signature so as to compute a first result and is applied to the message so as to compute a second result. The message is verified by comparing the first result to the second result.

There is additionally provided, in accordance with an embodiment of the present invention, cryptographic apparatus, including a memory, which is configured to store a private key corresponding to a public key that defines a multivariate polynomial mapping. A processor is configured to compute, using the private key, a digital signature for a message such that a first application of the mapping to the digital signature gives a first result, and a second application of the mapping to the message gives a second result that is equal to the first result, and to convey the message with the digital signature to a recipient for authentication using the public key.

There is further provided, in accordance with an embodiment of the present invention, cryptographic apparatus, including a memory, which is configured to store a predefined public key. A processor is configured to receive a message with a digital signature, to apply a multivariate polynomial mapping based on the public key to the digital signature so as to compute a first result, to apply the multivariate polynomial mapping based on the public key to the message so as to compute a second result, and to verify the message by comparing the first result to the second result.

There is moreover provided, in accordance with an embodiment of the present invention, a computer software product, including a computer-readable medium in which program instructions are stored, which instructions, when read by a processor, cause the processor to read from a memory a private key corresponding to a public key that defines a multivariate polynomial mapping, and to compute, using the private key, a digital signature for a message such that a first application of the mapping to the digital signature gives a first result, and a second application of the mapping to the message gives a second result that is equal to the first result, and to convey the message with the digital signature to a recipient for authentication using the public key.

There is furthermore provided, in accordance with an embodiment of the present invention, a computer software product, including a computer-readable medium in which program instructions are stored, which instructions, when read by a processor, cause the processor to read a predefined public key from a memory, to receive a message with a digital signature, to apply a multivariate polynomial mapping based on the public key to the digital signature so as to compute a first result, to apply the multivariate polynomial mapping based on the public key to the message so as to compute a second result, and to verify the message by comparing the first result to the second result.

The present invention will be more fully understood from the following detailed description of the embodiments thereof, taken together with the drawings in which:

### BRIEF DESCRIPTION OF THE DRAWINGS

FIG. 1 is a block diagram that schematically illustrates a data communication system in which messages are authenticated using a public-key signature, in accordance with an embodiment of the present invention;

FIG. 2 is a flow chart that schematically illustrates a method for transmitting a message with a digital signature, in accordance with an embodiment of the present invention; and

FIG. 3 is a flow chart that schematically illustrates a method for authenticating a message, in accordance with an embodiment of the present invention.

### DETAILED DESCRIPTION OF EMBODIMENTS

### Overview

Embodiments of the present invention that are described hereinbelow provide a new public-key signature scheme that can be implemented with relatively low expenditure of computational resources, while still providing high security against attack. This new scheme can use shorter keys than methods that are currently in common use and requires less computation for signature generation and verification. The disclosed embodiments are based on multivariate quadratic equations, but the principles of the present invention may be extended, mutatis mutandis, to multivariate polynomial equations of higher order.

To enable authentication of a message, the sender uses a private key to generate a digital signature over the message, using techniques described below. The signature has the form of a vector of values X=(x₁, . . . , xₙ) in a finite field Fₚ having p elements. To verify the authenticity of the message, the recipient uses a polynomial mapping P( ), typically having the form of multivariate quadratic mapping Q( ) over Fₚ. This mapping gives a result vector Y=(y₁, . . . , yₘ), i.e., (y₁, . . . , yₘ)=Q(x₁, . . . , xₙ). The mapping Q( ) comprises a set of multivariate quadratic equations of the form:

$${y}_{i} = {\sum }_{j , k}^{ } {γ}_{i} , j , {k}^{x} {j}^{x} k + {\sum }_{j}^{ } {β}_{i} , {j}^{x} j + {α}_{i} \qquad ( 1 )$$

The mapping coefficients γ_{i,j,k}, β_{i,j} and αᵢ are specified by the public key distributed by the sender of the message, i.e., the public key specifies the values of the coefficients that are to be used in the quadratic mapping by the recipient in authenticating the signature.

In some signature methods that are known in the art, the recipient computes a predefined hash function over the message and compares the hash result to the result of quadratic mapping of the signature. In embodiments of the present invention, however, the recipient applies the quadratic mapping Q( ) twice: once to the signature transmitted by the sender, in order to generate a first mapping result; and again to the message itself, to give a second result. Typically, the recipient computes this second result by applying a predefined hash function to the message to generate an input vector H=(h₁, . . . , hₙ), and then computes the second result Q(h₁, . . . , hₙ). If the first and second results are equal, i.e., Q(h₁, . . . , hₙ)=Q(x₁, . . . , xₙ), the message is authenticated. This sort of outcome, in which different input vectors give the same quadratic mapping result, is referred to herein as a “collision,” and the use of such collisions in signature verification is a feature of embodiments of the present invention.

In order to compute this sort of “collision signature” X over a given message, the signer uses a univariate polynomial function that is defined by the signer's private key and is associated with the multivariate polynomial mapping that is used in verifying the signature. (As explained in the above-mentioned article by Wolf and Preneel, there is a direct correspondence between these univariate and multivariate representations.) The univariate polynomial function operates over a finite field, which in this case is the extension field Fₚk, whose members correspond to vectors having k elements over the base field Fₚ. The members of Fₚk can be represented as polynomials of the form X=a₀+a₁t+ . . . +aₖ₋₁t^{k-1} in a variable t, wherein the polynomial coefficients aⱼ are equal to the corresponding vector elements, and there is an irreducible polynomial of degree k that operates in a manner equivalent to the modulus in number fields. (Irreducible polynomials can be found by choosing polynomials at random and testing for reducibility until an irreducible polynomial is found, or by selection from published tables of irreducible polynomials.) Computing the signature X in the polynomial representation facilitates efficient computation.

In the embodiments of the present invention that are described hereinbelow, the extension field Fₚk is defined such that the unity (i.e., the multiplicative neutral value, denoted 1) has multiple roots. In other words, there are multiple polynomials g in Fₚk such that g^{l}=1. To define the private key, a mapping function f over Fₚk is selected, of the form f(H)=H^{l}, such that l is a sum of two powers of p, and p^{k}−1 is divisible by l. (This choice of the extension field and mapping function is different from those used in cryptographic methods known in the art, which typically require that the unity have no roots other than itself.) The digital signature X for a given message is then computed by deriving a vector H from the message, typically by means of the same predefined hash function that is used in signature verification, and then computing, in polynomial terms, X=gH, wherein g is a polynomial in Fₚk such that g^{l}=1, as defined above. X is then converted to the vector form x₁, . . . , xₙ for transmission to the recipient.

Due to the properties that f(H)=H^{l} and g^{l}=1, the signature that is computed as X=gH will satisfy the verification requirement, set forth above, that f(X)=f(H), whether in the univariate or the equivalent multivariate domain. (The reason is that f(X)=g^{l}H^{l}=H^{l}=f(H).) Because f(X)=f(H), the quadratic mapping will also yield the same result when applied to the vectors X and H by the recipient in order to verify the message: Q(X)=Q(H). For the signer, the derivation of the coefficients of the multivariate quadratic mapping Q( ) that make up the public key and the computation of a collision signature, based on the private key, that satisfies the above requirement are straightforward and computationally undemanding operations.

On the other hand, solving a random set of multivariate quadratic equations in order to compute signatures is believed to be a hard problem.

The public key is distributed openly since it is used for signature verification. The private key is used for signing, and therefore should be known only to the signer. Thus, in the process of generating the public/private key pair, there are secret ingredients that are known only to the signer and cannot be deduced from the public key. The goal of these secret ingredients is to protect the private key from exposure and attack.

One way to safeguard the private key against attack is to apply two linear transformations A, B. The first mixes the variables x₁, . . . , xₙ to produce a new set of variables. The second mixes the set of quadratic forms Q=Q₁, . . . , Qₘ to produce a new set.

Another way to safeguard the private key against attack is to delete some variables and/or equations from the public key, so that only partial information is exposed to would-be attackers. This method imposes additional constraints on the signature vectors.

Yet another way to safeguard the private key against attack is to combine it with the “Unbalanced Oil and Vinegar” (UOV) signature scheme, as defined, for example, in U.S. Pat. No. 7,100,051, whose disclosure is incorporated by reference. In the private key representation of the UOV scheme, the variables are divided into two groups: an “oil” group and a “vinegar” group. The oil variables interact with all other variables, while the vinegar variables do not interact among themselves. In the public key representation, this special structure is concealed using linear transformations as defined above.

The combination of the collision signature and UOV schemes in the private key domain is done by taking the equations generated by the computational scheme described above as equations involving only oil variables. A sufficient number of UOV equations is then added, involving both oil and vinegar variables (recalling that the vinegar variables do not self-interact). The exact number UOV equations added depends on security versus performance considerations. Finally, all the variables are linearly mixed, and all quadratic forms are linearly mixed by transformations A and B as explained above.

### System Description and Operation

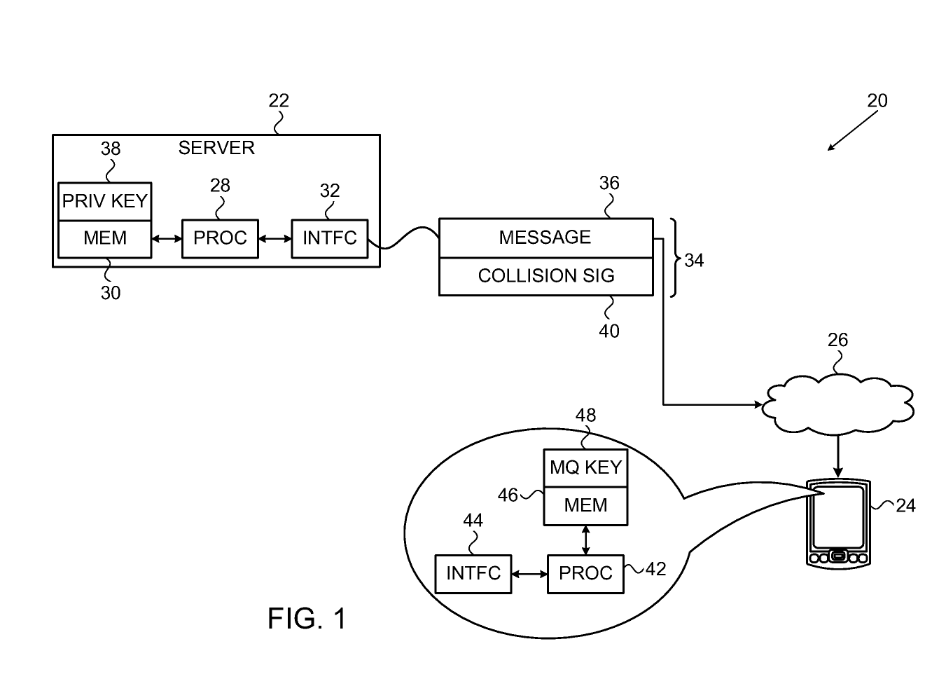

FIG. 1 is a block diagram that schematically illustrates a data communication system 20 using the sort of digital signature scheme that is described above, in accordance with an embodiment of the present invention. System 20 is shown and described here for the sake of example, to illustrate a typical configuration in which such digital signatures may be used, but is not meant to limit the application of such signatures to this sort of context.

In the pictured embodiment, a computer, such as a server 22 transmits data over a network 26 to a receiving device 24. Device 24 may comprise a media player, for example, either fixed or mobile, which comprises an embedded processor or has a plug-in smart card or key. Such devices typically having limited memory and computational resources, making the low resource demands of the present digital signature technique particularly attractive. Alternatively, the recipient of the data may be a general-purpose computer or other computing device.

In the example shown in the figure, a processor 28 in server 22 generates a message 36 for transmission to device 24. Processor 28 computes a collision signature 40, as defined above, over message 36 using a private key 38 that is stored in a memory 30. The server then transmits frame 34, comprising message 36 and signature 40, via an interface 32 over network 26 to device 24.

A processor 42 associated with device 24 receives frame 34 via an interface 44. Processor 42 sets up a quadratic mapping using a public multivariate quadratic (MQ) key 48 that is stored in a memory 46. This key may be preinstalled in memory 46, or it may be securely downloaded to device 24 from server 22 or from another trusted source. Processor 42 applies the quadratic mapping both to collision signature 40 and to a hash of message 36. If the results are equal, processor 42 authenticates the message as having originated from server 22, and media transmission proceeds.

Typically, processor 28, and possibly processor 42, as well, comprise general-purpose computer processors, which are programmed in software to carry out the functions that are described herein. This software may be downloaded to the either of the processors in electronic form, over a network, for example. Alternatively or additionally, the software may be provided on tangible, non-transitory storage media, such as optical, magnetic, or electronic memory media. Further alternatively or additionally, some or all of these processing functions may be performed by special-purpose or programmable digital logic circuits.

As noted above, FIG. 1 shows a certain operational configuration in which the signature scheme described herein may be applied. This same scheme may be applied in signing not only authentication frames transmitting over a network, but also in signing documents and files of other types, whether transmitted or locally stored. For the sake of convenience and clarity, the embodiments and claims in this patent application refer to computation of a signature over a message, but the term “message” should be understood, in the context of the present patent application and in the claims, as referring to any sort of data that is amenable to signature by the present scheme.

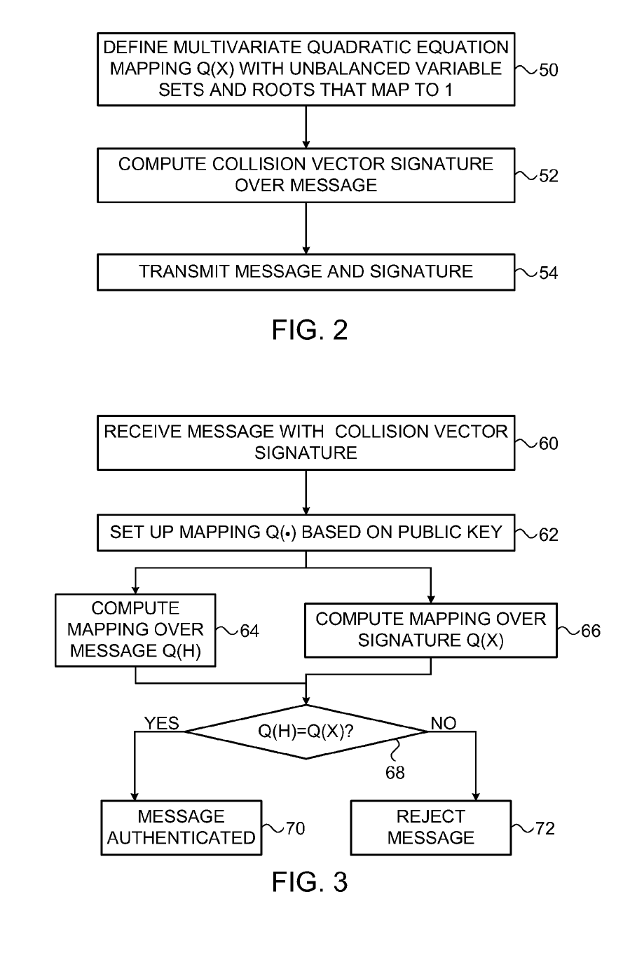

FIG. 2 is a flow chart that schematically illustrates a method for generating and transmitting a message with a digital signature, in accordance with an embodiment of the present invention. This method, as well as the method of FIG. 3 below, is described, for convenience and clarity, with reference to the elements of system 20 that are shown in FIG. 1.

Prior to computing collision signature 40, server 22 first receives or generates private and public keys, at a mapping definition step 50. The public key defines a multivariate quadratic mapping Q(X), comprising n variables x₁, . . . , xₙ and m equations, (Generally, m=n, although not necessarily.) This mapping is also published or otherwise known to devices that are to receive and verify the signature. The private key indicates the exponent value l to be used in the mapping function f over Fₚk, of the form f(H)=H^{l}, and may include the precomputed roots g of the unity in Fₚk. The private key also specifies the two linear transformations A, B as defined above, the separation of the variables into oil and vinegar sub-groups, and the additional UOV equations. Details of the method for defining the private key, its relation to the public key, and its use in generating collision signatures are presented below in an Appendix.

In preparation for transmitting message 36, server 22 computes collision signature 40 over the message, at a signature computation step 52. For this purpose, the server first computes a predefined hash function over the message to generate the hash vector H=(h₁, . . . , hₙ). The server then converts H to private key variables by multiplying it by the secret matrix A. Next, the server views the oil variables as a polynomial representing an element in Fₚk, selects any suitable unit root g (≠1), and multiples this polynomial by g to obtain a collision (on the oil equations). The server can now obtain a linear system of equation in the vinegar variables, which is solved using Gaussian elimination. Finally, the server transforms the collision vector from the private key domain to the public key domain by multiplying it by the matrix A⁻¹.

The result of these computations is a vector of coefficients that make up the collision signature. Server 22 transmits the message with this signature over network 26, at a transmission step 54.

FIG. 3 is a flow chart that schematically illustrates a method for authenticating a message, in accordance with an embodiment of the present invention. Device 24 receives message 36 with collision signature 40, at a message reception step 60. To authenticate the message, processor 42 sets up the mapping Q( ) that is specified by public key 48, i.e., it retrieves and arranges the coefficients to be used in the set of multivariate quadratic equations, at a mapping setup step 62. Processor 42 applies this mapping twice:
The processor computes a hash function over message 36 in order to derive the hash vector H, and then computes the result Q(H), at a first mapping step 64.
The processor computes the result Q(X) over the collision signature X that it received with the message, at a second mapping step 66.

Processor 42 compares these two results, at a comparison step 68. If Q(H)=Q(X), processor 42 concludes that message 36 is authentic, at a verification step 70. Otherwise, the processor concludes that the message is suspect and rejects the message, at a rejection step 72. Once the message has been authenticated, data communications between server 22 and device 24 can proceed. For example, message 36 may comprise a key for use by device 24 in decoding media transmitted over network 26 following the authentication exchange.

It will be appreciated that the embodiments described above are cited by way of example, and that the present invention is not limited to what has been particularly shown and described hereinabove. Rather, the scope of the present invention includes both combinations and subcombinations of the various features described hereinabove, as well as variations and modifications thereof which would occur to persons skilled in the art upon reading the foregoing description and which are not disclosed in the prior art.

### APPENDIX

### Choosing l

To explain how the value/is chosen for the polynomial mapping f(H)=H^{l}, we begin with some mathematical background. The number of elements in the extension field Fₚk is p^{k}, and the number of elements in its multiplicative group is p^{k}−1 (because the element 0 is omitted). Every non-zero element in XεFₚk satisfies the property X^{p̂k-1}=1. The multiplicative group of Fₚk is cyclic, and therefore there is a generator g whose powers span the entire multiplicative group. Consequently, the equation X^{l}=1 for l|p^{k}−1 (i.e., l that divides p^{k}−1) has exactly l solutions. In other words, for any such l, the unity (=1) has exactly l roots. More generally, the equation X^{l}=Y (in which Y is given and X is an unknown) has either 0 or 1 solutions.

In the field Fₚk, functions of the form X→X^{p̂i} are Frobenius automorphisms, meaning that for every pair X, YεFₚk, the following criteria are satisfied: (1) f(X+Y)=f(X)+f(Y); and (2) f(X*Y)=f(X)*f(Y). Since over the basic field Fₚ: X^{p}=X (by Euler's theorem), and thus X^{p̂i}=X (activating Euler's theorem i times), it follows that for every scalar XεFₚ: f(X*Y)=f(X)*f(Y)=X*f(Y). Therefore, functions of the form X→X^{p̂i} are linear functions over the base field Fₚ and can be represented as a k×k matrix over Fₚ. It follows that functions of the form X→X^{p̂i+p̂j}=X^{p̂i}X^{p̂j} are quadratic functions over the base field Fₚ, because they are a multiplication of two linear functions.

The parameter l that is used in the signature scheme described above is required to satisfy two properties: (1) The function X→X^{l} can be represented as a quadratic function over the base field and (2) The equation X^{l}=1 has multiple solutions (in which case the equation will have exactly l solutions, as explained above). Therefore, a suitable choice of l must satisfy two criteria: (1) It should be a sum of two powers of p: l=pⁱ+p^{j}; and (2) it should divide p^{k}−1 (formally, l|p^{k}−1).

A value of l satisfying these criteria may be found by a simple search. Since k is typically small (e.g., 64), and the maximal power of p is k, it is a simple matter to scan all the possible pairs i, j<k, until one finds l=pⁱ+p^{j} that also satisfies l|p^{k}−1. For example, for p=2, k=8, we can choose l=2²+2⁰=4+1=5, which also divides p^{k}−1=2⁸−1=255.

Because l|p^{k}−1, there is a group G containing l elements of Fₚk that are roots of the unity: gεG [symbol] g^{l}=1. The group G can be calculated by taking random elements from Fₚk, raising them to the power (p^{k}−1)/l, and saving the elements that yield the value 1 until all the l different roots of the unity are found. One of these roots is then chosen to multiply the hash value as part of the collision signature computation, as explained above.

### Constructing the Public/Private Key Pair

In an embodiment of the present invention, the public/private key pair is constructed as follows:
1. Choose a basic field Fₚ and an extension field Fₚk.
2. Choose an irreducible polynomial P₁ (X) with coefficients from Fₚ. X can be viewed also as X=(x₀, . . . , xₖ₋₁) wherein each xᵢ is a variable of Fₚ.
3. Use the transformation x→x^{l} in the field modulo Pₗ(X) and present the result as k quadratic forms over Fₚ: q₀(X), . . . , qₖ₋₁(X). Denote this collection of quadratic forms Q(X).
4. Add v new vinegar variables (xₖ, . . . , xₖ₊ᵥ₋₁) and add vv (<v) new randomly chosen UOV quadratic forms qₖ(X), . . . , qₖ₊ᵥᵥ₋₁(X) (in which vinegar variables do not interact with themselves).
5. Choose at random a (k+vv)×(k+vv) invertible matrix B and perform mixing of all the quadratic forms: Q(X)=BQ(X)
6. Choose at random a (k+v)×(k+v) invertible matrix A. Perform variable substitutions defined by Y=A(X).
7. The public key is Q(Y): a set of (k+vv) quadratic forms in (k+v) variables.

### Signing

As explained above, the signature is a vector S that produces a collision with H(M) (the hash of a message M) on the public key equations: Q(S)=Q(H(M)). In an embodiment of the present invention, the signature of a message M is computed as follows:
1. Calculate a cryptographic hash on the message H(M), which includes (k+v) elements in Fₚ.
2. Multiply H(M) by A to obtain h′=A H(M)
3. View h′ as k+v elements in Fₚk and substitute them into the private vv UOV quadratic forms. The result vector of vv Fₚ elements is W.
4. View the first k coordinates of h′ as an element in Fₚk and multiply it by a random unit-root vector g(≠1)εG:x=g·h′|ₖ.
5. Substitute the k entries of x as the oil variables in the private vv quadratic forms, and the vv entries of W as their results. The outcome is vv linear equations in the v vinegar variables.
6. Solve the linear system of equations (vv equations in v variables). If this system cannot be solved, return to step 4. Otherwise the solution gives values for all the variables X=(x₀, . . . , xₖ₊ᵥ₋₁).
7. The signature is Y=A⁻¹X.

### Verifying

To verify the signature S on a message M, the recipient performs the following steps:
1. Calculate the cryptographic hash on the message, H(M), and treat it as (k+v) elements in Fₚ.
2. For i=0, . . . , k+vv−1 verify that Qᵢ(S)=Qᵢ(H(M))

As noted earlier, a correct signature constitutes a collision to the hash of the message under the transformation defined by the public key (and not a pre-image as in other signature schemes).

1. A cryptographic method, comprising:
providing a key pair that comprises a private key and corresponding public key, which defines a multivariate polynomial mapping;
computing, using a processor and the private key, a digital signature for a message such that a first application of the mapping to the digital signature gives a first result, and a second application of the mapping to the message gives a second result that is equal to the first result; and
conveying the message with the digital signature to a recipient for authentication using the public key.

2. The method according to claim 1, and comprising:
receiving the message with the digital signature; and
authenticating the message by computing the first and second results using the multivariate polynomial mapping defined by the public key, and verifying that the first and second results are equal.

3. The method according to claim 1, wherein computing the digital signature comprises computing a predefined hash function over the message to produce an input vector H, and finding the digital signature X under the multivariate polynomial mapping P( ) such that X≠H while P(H)=P(X).

4. The method according to claim 1, wherein the private key defines a set of multivariate equations, and wherein providing the key pair comprises generating the public key by mixing the multivariate equations using linear transformations.

5. The method according to claim 1, wherein the private key defines multivariate equations in a set of variables, and wherein providing the key pair comprises generating the public key by mixing the variables using linear transformations.

6. The method according to claim 1, wherein the private key defines a set of multivariate equations, and wherein providing the key pair comprises generating the public key by deleting one or more of the multivariate equations from the public key.

7. The method according to claim 1, wherein the private key defines multivariate equations in a set of variables, and wherein providing the key pair comprises generating the public key by deleting one or more of the variables from the public key.

8. The method according to claim 1, wherein computing the digital signature comprises applying a univariate polynomial function, corresponding to the multivariate polynomial mapping, over a finite field comprising a unity element 1, wherein the finite field is defined such that 1 has multiple roots.

9. The method according to claim 8, wherein the finite field is an extension field Fₚk comprising members that correspond to vectors having k elements over a base field of p elements, and wherein the univariate polynomial function f is selected so that for a vector H in Fₚk, f(H)=H^{l}, such that l is a sum of integer powers of p, and p^{k}−1 is divisible by l.

10. The method according to claim 9, wherein computing the digital signature X comprises deriving the vector H from the message, and computing, in polynomial terms, X=gH, wherein g is a polynomial such that g^{l}=1.

11. The method according to claim 1, wherein the multivariate polynomial mapping is a quadratic mapping.

12. The method according to claim 11, wherein the private key defines a set of quadratic equations in accordance with an unbalanced oil and vinegar (UOV) scheme, such that the equations comprise first and second groups of variables having respective first and second sizes, wherein the variables in the second group do not self-interact, and the ratio between the first and second sizes is selected so as to ensure that the UOV scheme is secure.

13. A cryptographic method, comprising:
receiving a message with a digital signature, for verification using a predefined public key;
applying a multivariate polynomial mapping based on the public key to the digital signature so as to compute a first result;
applying the multivariate polynomial mapping based on the public key to the message so as to compute a second result; and
verifying the message by comparing the first result to the second result.

14. The method according to claim 13, wherein applying the multivariate polynomial mapping to the message comprises computing a predefined hash function over the message to produce an input vector H, and computing the multivariate polynomial mapping P over the input vector to give the second result P(H), for comparison with the first result P(X), wherein X is the digital signature, and X≠H.

15. The method according to claim 14, wherein verifying the message comprises verifying that P(X)=P(H).

16. The method according to claim 13, wherein the multivariate polynomial mapping is a quadratic mapping.

17. The method according to claim 16, wherein the quadratic mapping comprises first and second unbalanced groups of variables in a set of multivariate quadratic equations, wherein the variables in the second group do not self-interact.

18. The method according to claim 13, wherein the multivariate polynomial mapping corresponds to a univariate polynomial function that operates over a finite field comprising a unity element 1, and wherein the finite field is defined such that 1 has multiple roots.

19. Cryptographic apparatus, comprising:
a memory, which is configured to store a private key corresponding to a public key that defines a multivariate polynomial mapping; and
a processor, which is configured to compute, using the private key, a digital signature for a message such that a first application of the mapping to the digital signature gives a first result, and a second application of the mapping to the message gives a second result that is equal to the first result, and to convey the message with the digital signature to a recipient for authentication using the public key.

20. The apparatus according to claim 19, and comprising a device coupled to receive the message with the digital signature, and to authenticate the message by computing the first and second results using the multivariate polynomial mapping defined by the public key, and verifying that the first and second results are equal.

21. The apparatus according to claim 19, wherein the processor is configured to compute a predefined hash function over the message to produce an input vector H, and to find the digital signature X under the multivariate polynomial mapping P( ) such that X≠H while P(H)=P(X).

22. The apparatus according to claim 19, wherein the multivariate polynomial mapping is a quadratic mapping.

23. The apparatus according to claim 22, wherein the private key defines a set of quadratic equations in accordance with an unbalanced oil and vinegar (UOV) scheme, such that the equations comprise first and second groups of variables having respective first and second sizes, wherein the variables in the second group do not self-interact, and the ratio between the first and second sizes is selected so as to ensure that the UOV scheme is secure.

24. The apparatus according to claim 19, wherein the private key defines a set of multivariate equations, and wherein the processor is configured to generate the public key by mixing the multivariate equations using linear transformations.

25. The apparatus according to claim 19, wherein the private key defines multivariate equations in a set of variables, and wherein the processor is configured to generate the public key by mixing the variables using linear transformations.

26. The apparatus according to claim 19, wherein the private key defines a set of multivariate equations, and wherein the processor is configured to generate the public key by deleting one or more of the multivariate equations from the public key.

27. The apparatus according to claim 19, wherein the private key defines multivariate equations in a set of variables, and wherein the processor is configured to generate the public key by deleting one or more of the variables from the public key.

28. The apparatus according to claim 19, wherein the processor is configured to compute the digital signature by applying a univariate polynomial function, corresponding to the multivariate polynomial mapping, over a finite field comprising a unity element 1, wherein the finite field is defined such that 1 has multiple roots.

29. The apparatus according to claim 28, wherein the finite field is an extension field Fₚk comprising members that correspond to vectors having k elements over a base field of p elements, and wherein the univariate polynomial function f is selected so that for a vector H in Fₚk, f(H)=H^{l}, such that l is a sum of integer powers of p, and p^{k-1} is divisible by l.

30. The apparatus according to claim 29, wherein the processor is configured to compute the digital signature X by deriving the vector H from the message, and computing, in polynomial terms, X=gH, wherein g is a polynomial such that g^{l}=1.

31. Cryptographic apparatus, comprising:
a memory, which is configured to store a predefined public key; and
a processor, which is configured to receive a message with a digital signature, to apply a multivariate polynomial mapping based on the public key to the digital signature so as to compute a first result, to apply the multivariate polynomial mapping based on the public key to the message so as to compute a second result, and to verify the message by comparing the first result to the second result.

32. The apparatus according to claim 31, wherein the processor is configured to apply the multivariate polynomial mapping to the message by computing a predefined hash function over the message to produce an input vector H, and computing the multivariate polynomial mapping P over the input vector to give the second result P(H), for comparison with the first result P(X), wherein X is the digital signature, and X≠H.

33. The apparatus according to claim 32, wherein the processor is configured to verify that P(X)=P(H).

34. The apparatus according to claim 31, wherein the multivariate polynomial mapping is a quadratic mapping.

35. The apparatus according to claim 34, wherein the quadratic mapping comprises first and second unbalanced groups of variables in a set of multivariate quadratic equations, wherein the variables in the second group do not self-interact.

36. The apparatus according to claim 31, wherein the multivariate polynomial mapping corresponds to a univariate polynomial function that operates over a finite field comprising a unity element 1, and wherein the finite field is defined such that 1 has multiple roots.

37. A computer software product, comprising a computer readable medium in which program instructions are stored, which instructions, when read by a processor, cause the processor to read from a memory a private key corresponding to a public key that defines a multivariate polynomial mapping, and to compute, using the private key, a digital signature for a message such that a first application of the mapping to the digital signature gives a first result, and a second application of the mapping to the message gives a second result that is equal to the first result, and to convey the message with the digital signature to a recipient for authentication using the public key.

38. A computer software product, comprising a computer-readable medium in which program instructions are stored, which instructions, when read by a processor, cause the processor to read a predefined public key from a memory, to receive a message with a digital signature, to apply a multivariate polynomial mapping based on the public key to the digital signature so as to compute a first result, to apply the multivariate polynomial mapping based on the public key to the message so as to compute a second result, and to verify the message by comparing the first result to the second result.

39. A cryptographic method, comprising:
providing a key pair that comprises a private key and corresponding public key, which defines a multivariate polynomial mapping;
computing, using a processor and the private key, a digital signature X for a message by deriving from the message a vector H in a finite field Fpk, which comprises a unity element 1 and is defined such that 1 has multiple roots including a polynomial g, and computing, in polynomial terms, X=gH, such that a first application of the mapping to the digital signature gives a first result, and a second application of the mapping to the message gives a second result that is equal to the first result; and
conveying the message with the digital signature to a recipient for authentication using the public key.
